(19) United States
(12) Patent Application Publication
(10) Pub. No.: US 2011/0279377 A1
(43) Pub. Date: Nov. 17, 2011

(54) ILLUMINATION KEYBOARD

(75) Inventors: Ching-Cheng TSAI, Keelung City (TW); Chia-Hsin CHEN, Taipei City (TW); Chien-Shuo CHEN, Taoyuan County (TW)

(73) Assignee: CHICONY ELECTRONICS CO., LTD., TAIPEI COUNTY (TW)

(21) Appl. No.: 12/876,142

(22) Filed: Sep. 5, 2010

(30) Foreign Application Priority Data
May 14, 2010 (TW) 99209114

(51) Int. Cl. G06F 3/02

(52) U.S. Cl. 345/170

(57) ABSTRACT

An illumination keyboard is provided and includes a base plate, at least one tortuous circuit, a plurality of light sources, a light guide plate and a plurality of keys. The tortuous circuit is disposed on the base plate in a nonlinear arrangement. The light sources are coupled to the tortuous circuit for emitting light towards at least one direction. The light guide plate is disposed on the base plate for uniformizing the light emitted by the light sources. The keys are disposed on the light guide plate and located in a keys area of the base plate. Each key has a light pervious region through which the light penetrates through the key. The tortuous circuit is not overlapped with the light pervious regions.

### RELATED APPLICATIONS

This application claims priority to Taiwan Application Serial Number 99209114, filed May 14, 2010, which is herein incorporated by reference.

### BACKGROUND

1. Field of Invention

The present invention relates to a keyboard. More particularly, the present invention relates to a keyboard having an illumination function.

2. Description of Related Art

With the advance of technologies, various electronic devices have been dominating modern people's daily lives. For example, the electronic devices such as desktop computers, notebook computers and mobile phones have become necessary tools for people's work and daily lives.

Commonly speaking, a user needs to use an input device to operate an electronic device. For example, a mouse or a keyboard is used to perform an action of moving a cursor or inputting data. The keyboards commonly seen on the market are mainly divided into mechanical keyboard and thin-film keyboards. Since using the so-called “scissor-type” mechanical structure, a thin-film keyboard can effectively shorten its key stroke and lower its thickness, so that the thin-film keyboard is more and more popular to consumers.

However, when operating a keyboard under an insufficient light or dark environment, a user may not be able to distinguish the signs printed on the keyboard clearly or even fail to see the key locations. In order to overcome the inconvenience caused by operating the keyboard under dark environments, keyboards with light-emitting elements appear in the markets, wherein one of their common allocations is to allocate a plurality of light-emitting elements on a circuit board, and dispose the circuit board having the light-emitting elements on one side of the keyboard. The light emitted by the light-emitting elements is uniformly diffused into an area under each key of the keyboard via a light guide plate, thereby enabling each key to have a light-emitting effect.

However, since the light-emitting elements are merely located on one side of the keyboard, the keys closer to the light-emitting elements will have higher brightness, and the keys farther away from the light-emitting elements will have lower brightness, thus lighting uniformity for the entire keyboard. Consequently, when operating the keyboard in a dark environment, a user will have difficulties to distinguish the keys of the key boards due to inconsistent brightness of the keys. Further, besides restricting the manners of allocating the light-emitting elements, such a method of allocating a plurality of light-emitting elements on one side of the keyboard also reduce the keyboard design flexibility.

### SUMMARY

Hence, an aspect of the present invention is to provide an illumination keyboard for resolving the problems of inconsistent brightness of the keys and allocation restriction of the light sources by using a tortuous circuit.

According an embodiment of the present invention, an illumination keyboard is provided, and includes a base plate, at least one tortuous circuit, a plurality of light sources, a light guide plate and a plurality of keys. The base plate has a keys area, and the tortuous circuit is disposed on the base plate and is at least partially located in the keys area. The light sources are coupled to the tortuous circuit for emitting light towards at least one direction. The light guide plate is disposed on the base plate for uniformizing the light emitted by the light sources. The keys are disposed on the light guide plate and are located in a keys area of the base plate. Each key has a light pervious region through which the light emitted by the light sources penetrates through the key. The tortuous circuit is not overlapped with the light pervious region of each of the keys.

In one embodiment, there is a gap among the keys, and the tortuous circuit is substantially located under the gap, and each of the light sources emits the light towards the key adjacent thereto.

In one embodiment, there are a lateral gap and a longitudinal gap among the keys. The tortuous circuit includes at least one lateral circuit and at least one longitudinal circuit. The lateral circuit is substantially parallel to the lateral gap, and the longitudinal circuit is substantially parallel to the longitudinal gap.

In one embodiment, the lateral circuit and the longitudinal circuit are alternately disposed.

In one embodiment, the at least one lateral circuit has a length smaller than the lateral width, or greater than multiple times of the lateral width.

In one embodiment, when the least one tortuous circuit includes a plurality of the lateral circuits, the lateral circuits are of equal length.

In one embodiment, when the least one tortuous circuit includes a plurality of the lateral circuits, the lateral circuits are of unequal length.

In one embodiment, one or more of the light sources are disposed on the least one lateral circuit.

In one embodiment, one or more of the light sources are disposed on the least one longitudinal circuit.

In one embodiment, the illumination keyboard further includes a reflection plate used for reflecting the light emitted by the light sources towards the keys.

In one embodiment, the tortuous circuit is a flexible printed circuited board (FPC).

In one embodiment, the light sources are light-emitting diodes (LEDs).

The illumination keyboards disclosed in the embodiments of the present invention use the method of allocating the light sources on the tortuous circuit to allow the light sources to be disposed corresponding to the areas except the light pervious regions, thereby assuring the light-emitting brightness of each key; promoting the light-emitting uniformity of the entire key board; and increasing the flexibility of allocating the light sources.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A is a perspective view of an illumination keyboard according to an embodiment of the present invention;

FIG. 1B is cross-sectional diagram of the illumination keyboard along line A-A′ shown in FIG. 1A;

FIG. 2 is a schematic diagram showing an arrangement of a tortuous circuit and light sources according to an embodiment of the present invention;

FIG. 3 is a schematic diagram showing an arrangement of a tortuous circuit and light sources according to another embodiment of the present invention;

FIG. 4 is a schematic diagram showing an arrangement of a tortuous circuit and light sources according to another embodiment of the present invention; and

FIG. 5 is a schematic diagram showing an arrangement of a tortuous circuit and light sources according to another embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

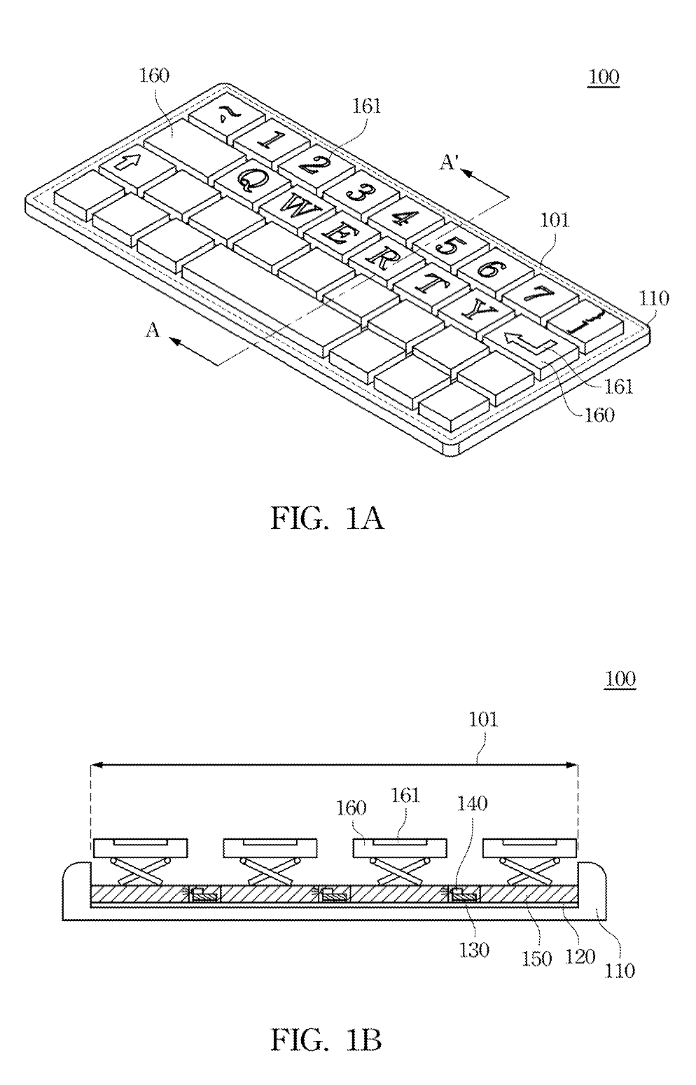

Referring to FIG. 1A and FIG. 1B simultaneously, FIG. 1A is a perspective view of an illumination keyboard 100 according to an embodiment of the present invention, and FIG. 1B is cross-sectional diagram of the illumination keyboard taken along line A-A′ shown in FIG. 1A. The illumination keyboard 100 includes a base plate 110, at least one tortuous circuit 130, a plurality of light sources 140, a light guide plate 150 and a plurality of keys 160. The base plate 110 is formed from, for example, metal or plastic material, and has sufficient mechanical strength to sustain the elements of the illumination keyboard 100. The base plate 110 has a keys area 101 used for disposing the keys 160 and their corresponding key-pressing mechanisms (such as scissors and elastic members, etc.). The tortuous circuit 130 is disposed on the base plate 110 in a nonlinear arrangement and is at least partially located in the keys area 101. The light sources 140 are coupled to the tortuous circuit 130 for emitting light towards at least one direction. The light guide plate 150 is disposed on the base plate 110 for uniformizing the light emitted by the light sources 140.

In the illumination keyboard 100, each of the keys 160 has a light pervious region 161, and the light emitted by the light sources 140 penetrates through the keys 160 via their respective light pervious regions 161. Further, in this embodiment, the aforementioned at least one tortuous circuit 130 is not located under the light pervious regions 161, i.e. is not overlapped with the light pervious regions 161. In other words, the area under the light pervious region 161 of each key 160 is directly corresponding to the light guide plate 150, thereby avoiding the problem of lowered light-emitting brightness caused by the tortuous circuit 13 absorbing the light. In one embodiment, the light pervious regions 161 are formed by, for example, laser engraving, and also can be letters, phonetic symbols, punctuation marks and numerals on the keys 161 through which the light is desired to pass, so that a user may be able to distinguish the respective keys 160 under an insufficient light or dark environment. The present invention does not intend to limit the material of the keys 160, the method for forming the light pervious regions 161 and the patterns of the light pervious regions 161, and thus all the keys having light pervious regions for transmitting out the light should be applicable to the illumination keyboard 100 of the present invention.

In the illumination keyboard 100 according to the embodiment of the present invention, the tortuous circuit 130 is disposed on the base plate 110 in a nonlinear arrangement and is at least partially located in the keys area 101. The tortuous circuit 130 can be a FPC, for example, and its tortuous pattern is related to the arrangement of the keys 160, which will be described in detail later. On actual applications, there is a gap among the keys 160, and the tortuous circuit 130 is substantially located under the gap, and is disposed bent around the respective keys 160. The light sources 140 coupled to the tortuous circuit 130 emit the light towards their adjacent keys 160 respectively, so that the light emitted by the light sources 140 may reach the keys within short distances and penetrate through the keys 160 via the light pervious regions, thereby avoiding the problem of lowered brightness caused after the light being reflected, refracted or scattered for a long distance in the light guide plate 150.

On the other hand, the illumination keyboard 100 of this embodiment further includes a reflection plate 120 disposed between the base plate 110 and the tortuous circuit 130 for reflecting the light emitted by the light sources 140 towards the keys 160, thereby promoting the light-emitting efficiency of the illumination keyboard 100. In another embodiment, the base plate 110 includes a reflection surface facing towards the light sources 140 for reflecting the light emitted by the light sources 140 towards the keys 160. Further, in this embodiment, the light sources 140 can be such as light emitting diodes (LEDs), which have the advantages of small size, low power consumption and high efficiency.

In an arrangement of the keys 160, there are a longitudinal gap between two laterally adjacent keys 160 and a laterally gap between two longitudinally adjacent keys 160. Further, the keys 160 on every two adjacent rows are alternately arranged for satisfying ergonomics requirements and increasing user's typing comfort. Hereinafter, the method for arranging the tortuous circuit, the light sources and the keys are explained.

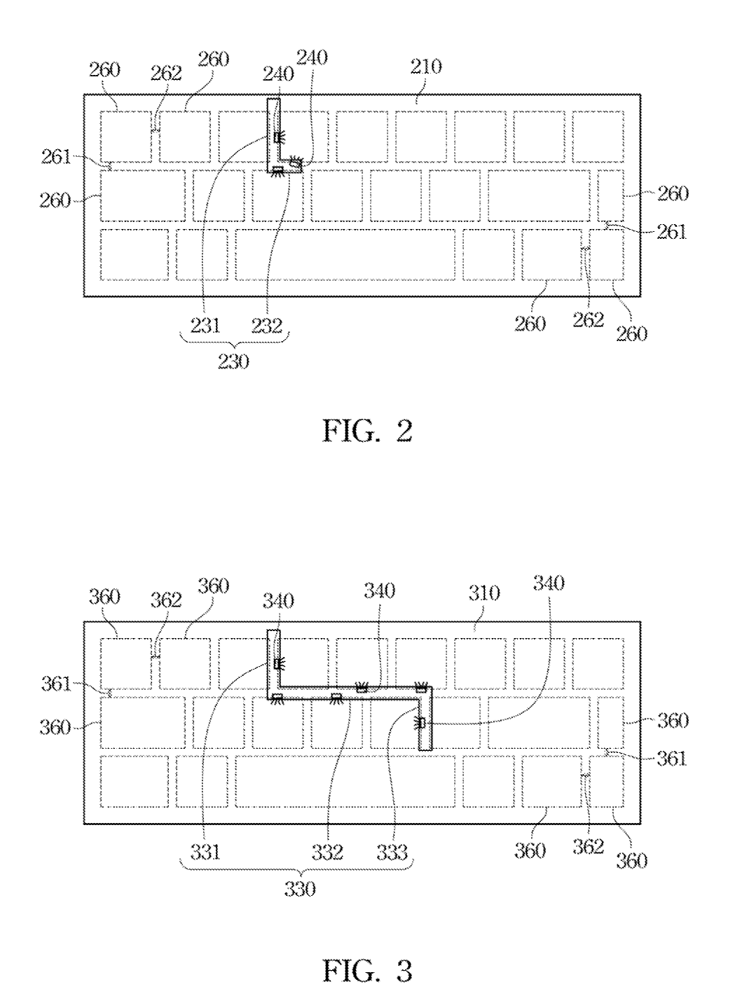

Referring to FIG. 2, FIG. 2 is a schematic diagram showing an arrangement of a tortuous circuit 230 and light sources 240 according to an embodiment of the present invention. In this embodiment, the tortuous circuit 230 and a plurality of keys 260 are disposed on a base plate 210, and the light sources 240 are disposed on the tortuous circuit 230. The keys 260 are arranged in the QWERTY layout, i.e. the keys 260 on two adjacent rows are alternately disposed. There are a lateral gap 261 and a longitudinal gap 262 among the keys 260. The tortuous circuit 230 includes at least one longitudinal circuit 231 and at least one lateral circuit 232 which are mutually connected. The lateral circuit 232 is substantially parallel to the lateral gap 261, and the longitudinal circuit 231 is substantially parallel to the longitudinal gap 262.

In this embodiment, one tortuous circuit 230 is used as an example for explanation, which includes one longitudinal circuit 231 and one lateral circuit 232 and appears in an about L-shape. The tortuous circuit 230 is located substantially under the lateral gap 261 and the longitudinal gap 262 but not under the light pervious regions (not shown in FIG. 2) of the respective keys 260, thereby preventing the tortuous circuit 230 from interfering the light-emitting paths of the light sources 240. On actual applications, one or more light sources 240 can be disposed on the lateral circuit 232, and also one or more light sources 240 can be disposed on the longitudinal circuit 231, according to product requirements.

In this embodiment, three light sources 240 are used as an example for explanation, wherein one light source 240 is disposed on the longitudinal circuit 231, and the other two light sources 240 are disposed on the lateral circuit 232. Each of the light sources 240 emits light towards its adjacent keys 260. As shown in FIG. 2, in this embodiment, these light sources 240 emit light towards three different directions respectively, including towards the right direction, towards the down direction and towards the upper-right direction.

Referring to FIG. 3, FIG. 3 is a schematic diagram showing an arrangement of a tortuous circuit and light sources according to another embodiment of the present invention. In this embodiment, one tortuous circuit 330 is used as an example for explanation. The tortuous circuit 330 is disposed on a base plate 310, and includes two longitudinal circuits 331 and 333 and one lateral circuit 332 which are mutually connected and appears in an about Z-shape. In this embodiment, the length of the lateral circuit 332 is exemplified as one greater than twice of the lateral width of one key 360. The tortuous circuit 330 is located substantially under a lateral gap 361 and longitudinal gaps 362 but not under the light pervious regions (not shown in FIG. 3) of the respective keys 360, thereby preventing the tortuous circuit 330 from interfering the light-emitting paths of the light sources 340.

Further, in this embodiment, six light sources 340 are used as an example for explanation, wherein one light source 340 is disposed on one of the longitudinal circuits 331, and four light sources 340 are disposed on the lateral circuit 332, and the other one light source 340 is disposed on the other longitudinal circuit 333. Each of the light sources 340 emits light towards its adjacent keys 360. As shown in FIG. 3, in this embodiment, these light sources 340 emit light towards four different directions respectively, including towards the right direction, towards the left direction, towards the down direction and towards the up direction.

Referring to FIG. 4, FIG. 4 is a schematic diagram showing an arrangement of a tortuous circuit and light sources according to another embodiment of the present invention. In this embodiment, one tortuous circuit 430 is used as an example for explanation. The tortuous circuit 430 is disposed on a base plate 410, and includes a first longitudinal circuit 431, a first lateral circuit 432, a second longitudinal circuit 433, a second lateral circuit 434 and a third longitudinal circuit 435 which are mutually connected. The lateral circuits 432 and 434 and the longitudinal circuits 431, 433 and 435 are alternately disposed, and the tortuous circuit 430 appears in a stairs shape. The tortuous circuit 430 is located substantially under lateral gaps 461 and longitudinal gaps 462 but not under the light pervious regions (not shown in FIG. 3) of the respective keys 460, thereby preventing the tortuous circuit 430 from interfering the light-emitting paths of the light sources 440.

In this embodiment, the length of the first lateral circuit 432 is greater than twice of the lateral width of one key 460, and the length of the second lateral circuit 434 is smaller than the lateral width of one key 460. Although, the embodiment in which the length of the first lateral circuit 432 is different from that of the second lateral circuit 434 is used as an example for explanation, yet the technique of the present invention is not limited thereto. In another embodiment, the length of the first lateral circuit 432 can be the same as that of the second lateral circuit 434, according to product requirements.

Further, in this embodiment, eight light sources 440 are used as an example for explanation, wherein one light source 440 is disposed on the first longitudinal circuit 431, and four light sources 440 are disposed on the first lateral circuit 432, and one light source 440 is disposed on the second longitudinal circuit 433, and one light source 440 is disposed on the second lateral circuit 434, and the other one light source 440 is disposed on the third longitudinal circuit 435. Each of the light sources 440 emits light towards its adjacent keys 460. As shown in FIG. 4, in this embodiment, these light sources 440 emit light towards a plurality of different directions respectively.

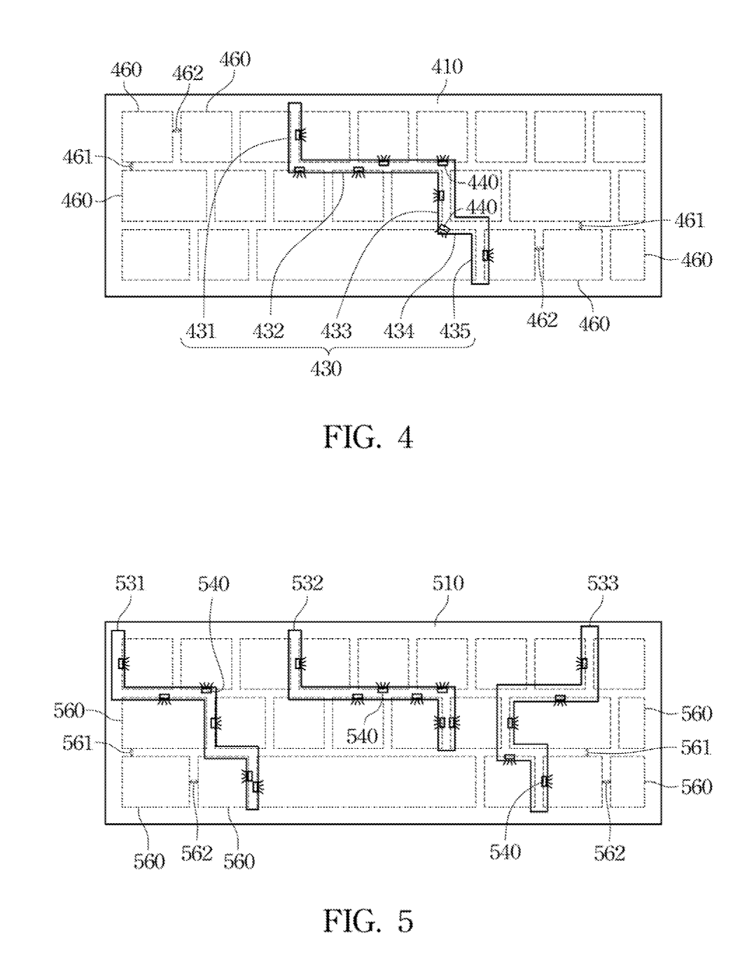

Referring to FIG. 5, FIG. 5 is a schematic diagram showing an arrangement of a tortuous circuit and light sources according to another embodiment of the present invention. In this embodiment, three tortuous circuits 531, 532 and 533 are used as an example for explanation, each tortuous circuit including at least one lateral circuit and at least one longitudinal circuit. It is worthy to be noted that, in this embodiment, these three tortuous circuits 531, 532 and 533 are disposed on a base plate 510 in different arrangement manners, thereby extending the tortuous circuits 531, 532 and 533 to near the keys 560 located on different rows and different columns so as to allow the light sources 540 disposed on the tortuous circuits 531, 532 and 533 to emit light towards their adjacent keys 560. The tortuous circuits 531, 532 and 533 are located substantially under lateral gaps 561 and longitudinal gaps 562 but not under the light pervious regions (not shown in FIG. 5) of the respective keys 560, thereby preventing the tortuous circuits 531, 532 and 533 from interfering the light-emitting paths of the light sources 540.

The embodiments of the present invention merely list the aforementioned tortuous circuits 230, 330, 430, 531, 532 and 533 (as shown in FIG. 2 to FIG. 5) as examples for explanation, but do not intend to limit the present invention thereto. Other manners for arranging one or more tortuous circuits are all within the scope of the present invention, as long as the tortuous circuits includes one or more lateral circuits and one or more longitudinal circuits; and the tortuous circuits are disposed along the gaps among the keys and are not under the light pervious regions of the keys.

According to the above embodiments, the illumination keyboards use one or more tortuous circuits which are disposed along the gaps among the keys without overlapping with the light pervious regions, thus shortening the light emitting paths between the light sources and the keys, thereby effectively promoting the illumination efficiency of the keyboard. Moreover, using the tortuous circuits for disposing the light sources can easily avoid touching the mechanisms and circuits related to the keys, thereby providing methods for arranging the light sources rapidly, economically and conveniently, and meanwhile increasing the flexibility of allocating the light sources

It will be apparent to those skilled in the art that various modifications and variations can be made to the structure of the present invention without departing from the scope or spirit of the invention. In view of the foregoing, it is intended that the present invention cover modifications and variations of this invention, provided they fall within the scope of the following claims and their equivalents.

What is claimed is:

1. An illumination keyboard, comprising:
a base plate having a keys area;
at least one tortuous circuit which is disposed on the base plate in a nonlinear arrangement and is at least partially located in the keys area;
a plurality of light sources coupled to the tortuous circuit for emitting light towards at least one direction;
a light guide plate disposed on the base plate for uniformizing the light emitted by the light sources; and
a plurality of keys which are disposed on the light guide plate and are located in a keys area of the base plate, each of the keys having a light pervious region through which the light emitted by the light sources penetrates through the each of the keys, wherein the tortuous circuit is not overlapped with the light pervious region of each of the keys.

2. The illumination keyboard as claimed in claim 1, wherein there is a gap among the keys, and the at least one tortuous circuit is substantially located below the gap.

3. The illumination keyboard as claimed in claim 2, wherein each of the light sources emits the light towards the key adjacent thereto.

4. The illumination keyboard as claimed in claim 1, wherein there are a lateral gap and a longitudinal gap among the keys, the at least one tortuous circuit comprising:
at least one lateral circuit substantially parallel to the lateral gap; and
at least one longitudinal circuit which is connected to the at least one lateral circuit and is substantially parallel to the longitudinal gap.

5. The illumination keyboard as claimed in claim 4, wherein the at least one lateral circuit and the at least one longitudinal circuit are alternately disposed.

6. The illumination keyboard as claimed in claim 4, wherein each of the keys having a lateral width, and the at least one lateral circuit has a length smaller than the lateral width.

7. The illumination keyboard as claimed in claim 4, wherein each of the keys having a lateral width, and the at least one lateral circuit has a length greater than multiple times of the lateral width.

8. The illumination keyboard as claimed in claim 4, wherein when the least one tortuous circuit comprises a plurality of the lateral circuits, the lateral circuits are of equal length.

9. The illumination keyboard as claimed in claim 4, wherein when the least one tortuous circuit comprises a plurality of the lateral circuits, the lateral circuits are of unequal length.

10. The illumination keyboard as claimed in claim 4, wherein one or more of the light sources are disposed on the least one lateral circuit, and one or more of the light sources are disposed on the least one longitudinal circuit.
